(19) United States
(12) Patent Application Publication
(10) Pub. No.: US 2016/0292755 A1
(43) Pub. Date: Oct. 6, 2016

(54) Method and Apparatus for Funding Causes Through a Gaming Platform

(71) Applicant: goodXgames, Inc., Maitland, FL (US)

(72) Inventor: Bradley Bulifant, Windermere, FL (US)

(21) Appl. No.: 15/088,027

(22) Filed: Mar. 31, 2016

Related U.S. Application Data
(60) Provisional application No. 62/141,225, filed on Mar. 31, 2015.

(51) Int. Cl. G06Q 30/02

(52) U.S. Cl. CPC G06Q 30/0279

(57) ABSTRACT

A system and a method is provided that allows for individuals, groups, corporations and others to provide benefits to beneficiaries through a common platform that has activities and other opportunities to provide funds to the beneficiaries. Users can also leverage the system by their activities and associations with other users/groups/corporations/to increase their benefits to the beneficiaries. The system tracks the benefits and, based on reports from the beneficiaries, provides details on the impact of users' contributions to the beneficiaries.

### REFERENCE TO RELATED CASE

This application claims priority under 35 U.S.C. §119 (e) to provisional application No. 62/141,226 filed on Mar. 31, 2015, the contents of which are hereby incorporated by reference in their entirety.

### BACKGROUND OF THE INVENTION

### Field of the Invention

Many people, either as an individual or maybe as a group, would like to make the world a better place. This can be done in a number of ways—contributing to a non-profit that supports a cause the person agrees with. Volunteering at the local shelter. Or perhaps even starting their own business that achieves their goals. However, most people do not even know where to begin. They may be overwhelmed with information, be confused as to the real goals of certain charities, or see that the charities do not use the received funds in an efficient manner. Thus, many people may not do anything for fear of doing the wrong thing.

If an avenue were available that allowed people to remain within their comfort zones and still provide a benefit, more people would chose to participate. The present system allows people from all over the world to engage with one another, participate in activities, purchase goods and services, including playing games, and make contributions, all of which can be used to benefit a charity or cause they support.

### SUMMARY OF THE INVENTION

The present invention is directed to a method of providing a platform to provide for contributions to a beneficiary and monitoring the contributions including the steps of providing an electronic platform to support multiple users accessing the platform, providing access to at least one electronic area in the electronic platform for a registered user, providing at least one activity for the registered user to engage in the at least one electronic area, providing a point system to award points to the registered user based upon an activity engaged in by the registered user in the at least one electronic area, awarding points under the point system to the registered user for participating in an activity, contributing funds to a beneficiary, the contributed funds corresponding to the points awarded to the registered user, receiving from the beneficiary a report on use of the funds by the beneficiary, and reporting to the user the funds contributed to the beneficiary and the reported use of the funds through the electronic platform.

In some embodiments, the at least one electronic area is supported by a contributor and the funds are provided by the contributor to the beneficiary.

In some other embodiments, the at least one activity includes the playing an electronic game on a handheld device that communicates with the system so the electronic platform may update the point system.

According to another aspect of the present invention a system for providing a platform to provide for contributions to a beneficiary and monitoring the contributions, the system including at least one computer processor coupled with a tangible machine-readable medium having a set of instructions for a method stored thereon, the method includes the steps of providing an electronic platform to support multiple users accessing the platform, providing access to at least one electronic area in the electronic platform for a registered user, providing at least one activity for the registered user to engage in the at least one electronic area, providing a point system to award points to the registered user based upon an activity engaged in by the registered user in the at least one electronic area, awarding points under the point system to the registered user for participating in an activity, contributing funds to a beneficiary, the contributed funds corresponding to the points awarded to the registered user, receiving from the beneficiary a report on use of the funds by the beneficiary, and reporting to the user the funds contributed to the beneficiary and the reported use of the funds through the electronic platform.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a schematic of a system that can be used to implement one embodiment of a method according to the present invention; and

FIG. 2 is a schematic of the server associated with the provider;

FIG. 3 is a schematic of the server associated with the contributor/beneficiary; and

FIG. 4 is an example of a screen presented to a user of the present system.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

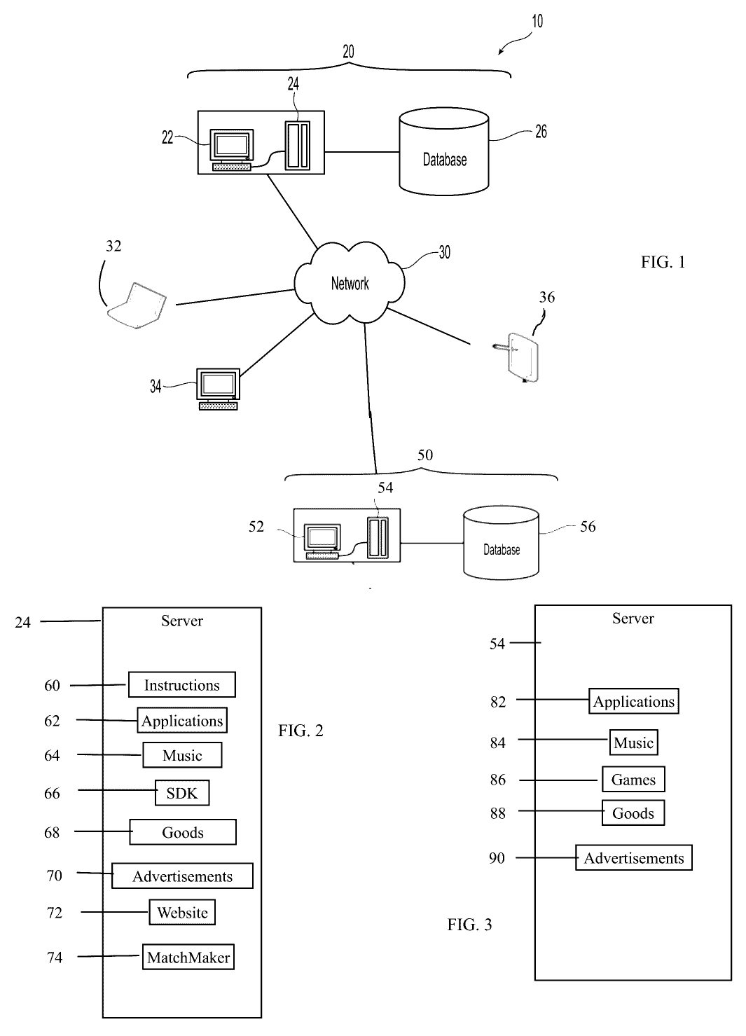

Referring to FIG. 1, a schematic of one embodiment of a system 10 that can be used with the method according to the present invention. As may be understood the system 10 includes a base information technology (IT) structure 20 for the provider. The provider's IT structure 20 further includes a computer 22 connected to a server 24, which is also connected to a database 26. The computer 22 is operated by the provider who is responsible for managing and updating the system. The computer 22 is in turn in communication with the server 24 to provide access to a database 26 and also a network 30. The database 26 includes the data necessary for implementing the method, as discussed in more detail below, as well as other information. The server 24 allows communication by and between the computer 22, the database 26, and the network 30. The server 24 (or the computer 22) may also have stored thereon computer programs, applications, virtual goods, downloadable files, etc. There are also other IT structures 50 that also include a computer 52 connected to a server 54, which is also connected to a database 56. As described in more detail below, there will be such a IT structure 50 for each of the contributors/developers that are a part of the system 10. Each of the IT structures 50 may be configured slightly different from that illustrated depending upon the need of the contributors/developers that own and control the IT structures 50. For example, some contributor/developer may not need to have a separate database as the information may be stored with the IT structure 20, but accessible to the other contributors/developers.

A plurality of computers, including a lap top computer 32, a desk top computer 34, and a tablet/phone 36 may also be connected to the IT structures 20, 50 through the network 30 as allowed by the provider's computer 22 through the server 24. As the IT structures 50 discussed above may have additional units, any number of computers/tablets/phones 32,34,36 may be connected to the system 10 through the network 30.

As illustrated in FIG. 2, the server 24 has stored on it the instructions 60 that are needed to allow for the method of the present application to be implemented. As described below, the server 24 may also have applications 62, music 64, SDK (software development kit) 66, and goods 68 that can be purchased, and advertisements 70 for various companies that can be viewed by users using the computers 32,34,36. Naturally, also stored on the server 24 is a website 72 that functions as a gateway for the users (and also the contributors and beneficiaries) into the system. A matchmaker module 72 is also present on the server 24, which matches the users with contributors and also the contributors with the beneficiaries based on number of choices/preferences made by the users, the contributors, and the beneficiaries within the system 10.

As illustrated in FIG. 3, the server 54 for a contributor/beneficiary has stored on it applications 82, music 84, games 86, goods 68, and advertisements 90 for that can be viewed by users using the computers 32,34,3

While a detailed discussion of the system 10 is provided below, generally the present invention is directed to the ability of users (through computers 32,34,36) to use the system 10 to view and engage with the content of contributors to earn points. The contributors, based upon the activities of the users, contribute funds to approved beneficiaries/charities that (may) have similar goals and viewpoints as the contributors. The contributors can make available to the users activities that include playing downloadable and on-line games, making in-game purchases, purchasing merchandise that may be related to the beneficiaries/charities (beneficiaries) or the contributors themselves, purchasing music, etc. The contributors may be companies, individuals, or software developers, or other entities who would like to provide content available on the system 10 and can then make contributions to the beneficiaries. The beneficiaries would then use the contributions to provide goods or services as identified. The system 10 maintains and tracks the activities of the users, the donations made by the contributors, the use of the funds by the beneficiaries. The system can identify in real time the effect that the users have had based upon the use of the funds by the beneficiaries and reported to the users, contributors and beneficiaries.

The system 10 provides an electronic platform to integrate the input and data from a number of entities. As noted above, there are generally four different entities that use the system 10. The first is the provider who has established the system and allows the system to function through the IT structure 20 and other components as noted below. Second are the contributors/developers that integrate the functionality of the system 10 into their IT structures 50 using the SDK 66 (software development kit). The contributor/developer (“contributor”) may be an organization, a consumer, an influencer, and/or a brand. In turn, influencers are generally considered celebrities, recording artists, comedians, activists, etc. Developers are those entities that provide applications (apps) to be used by the users. Generally, all contributors must sign up with the provider by accessing the website 72. They will create an account with the provider on IT structure 20. The contributor will identify the beneficiaries that it will contribute to or alternatively list any causes that are relevant for the purpose of attracting users, create the activities that the users may engage in using the SDK 66 (see also below), provide information, such as ads and videos, that are used on the provider's website 72 to attract users to its activities, and identify an amount from each of the activities that will be contributed to the beneficiaries it has agreed to donate funds to.

After signing up, the contributors will be able to access a dashboard that will illustrate the contributor's activities, the contributions made, and the impact of those contributions to the beneficiaries.

The beneficiaries will also be able to sign up with the provider by accessing the website 72. They too will create an account with the provider on IT structure 20. Entities such as non-profit organizations, benefit corporations, for-profit organizations, foundations, and social enterprises may be considered to be beneficiaries under the present invention. The entity will have to prove that is providing services to others in order to register as a beneficiary under the system 10. This may include a history of charitable causes, donations made, etc. The beneficiary may also be required to identify the deliverables (i.e., service/good provided) under the system 10, along with financial information about those deliverables. For example, sales price of the goods, cost of the goods, number of goods sold each year, what are the targets for the coming years, the number of people served, etc. The beneficiaries will also have to agree to provide information about the deliverables and where the deliverables were provided. This information will be captured by the system 10 and stored in the database 26. The system 10 can use this information to provide feedback to the contributors and users as to the effectiveness of the beneficiary and to demonstrate the impact that the user and the contributor have on the world through the beneficiary.

Next, the user will have to sign up through the website 72. They too will create an account with the provider on IT structure 20. During registration, the user will identify those causes or beneficiaries that the user would like to support. If the user does not identify a particular cause or beneficiary, then the system 10 will provide options to the user. If the user identifies types of charities or causes during registration, the system 10, through the matchmaker module 74, will take the information entered by the user and determine the best beneficiaries registered with the system 10. Those will then be presented to the user to select from, as well as the corresponding contributors for that beneficiary (if there is more than one). Once the user has selected the contributor that supports the user's causes, the user is presented with the activities sponsored by that contributor. It should be noted that the contributors and the beneficiaries may also sign up as users to highlight and bring attention to their own causes.

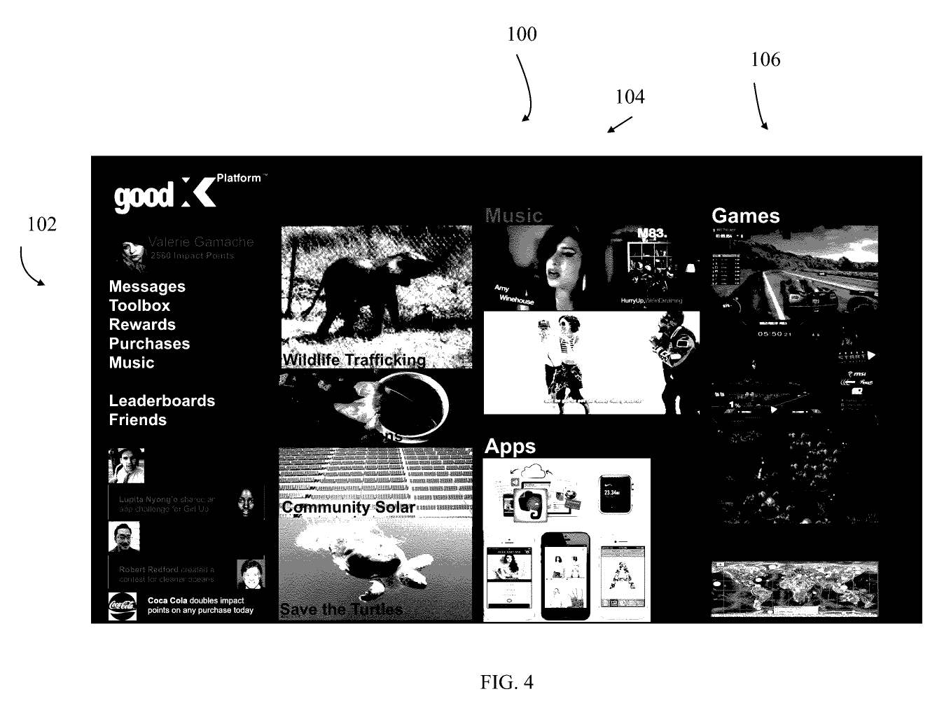

An example of a user's screen is illustrated in FIG. 4. The screen 100 has a number of links 102 that open other screens on the user's computer (32,34,36). As illustrated, there are screens for messages, toolbox, rewards, purchases, music, impact, leaderboards, friends, and impact stream. Under the messages screen are messages that can be sent by the provider, contributor, friends to the user. The toolbox provides tools to facilitate interactions and sharing for all platform users and products. Each item in the toolbox is designed to incentivize multiple ways for the user to earn Impact Points, generating impact and building awareness of the platform across social media channels. As one example, users or teams can challenge each other to a duel where winner will earn points, loser could make a contribution or perform an impact action. Or users will be provided with options to share cause related info or registered impact opportunities in exchange for points and they can invite friends to join a team. On the contributor side, the toolbox allows the contributor to set up such challenges or suggest actions.

The rewards screen will provide any rewards that may be provided by the contributor, offers from the contributor or any achievements by the user. The purchases screen provides goods and services that are made available by the contributor, essentially an on-line store for the user. Generally, any such goods/services would be stored on the contributor's server 54 as element 88, but could be housed on the provider's IT structure 20 as well. The music screen would provide a list of music 84 that are available to the user that are available for purchase/down-loading. The music 84 and/or artists may be related to the causes identified by the contributor/user/beneficiary. The impact screen keeps track of the points awarded to the user and the affect that the user has had on the beneficiary. Similarly, the leaderboards show the progress of the user relative to others who have selected the same contributor. The data provided may also show not only the points received from participating in the contributor's activities, but also the progress toward any goal that the user has set. For example, the user may have set a goal of providing solar lights to people who may not have access to electricity all of the time. Progress to such a goal would be shown here.

The user may convince friends to sign up or make friends during their time playing or participating in activities. These people would be listed in the friends section. There may also be other links on the screen 100—for example, a link 104 directly to music or a link 106 to the games. While the games is presented on the screen 100, generally the games link will take the user to a third party website to download the game (or app) sponsored by the contributor onto the user's computer 32,34,36. The contributor may also allow for it to be downloaded directly from the server 54. After the user downloads the games/apps, the results of those activities are transmitted from the user's computer back to the contributor's IT structure 50. Similarly, once the data has been received by the contributor's IT structure 50, it is also transmitted to the provider's IT structure 20 and saved in the database 26. This allows for the provider to provide the necessary data to the users, the contributors and the beneficiaries. It should be noted that this information is provided to the contributor and then the provider in real time. When the provider updates the user's information, it is possible for the user to see how close they are to or have reached any of the goals they may have set.

The ability of the contributor to integrate their material with that of the system is provided by the SDK (software development kit—or toolbox) 66. As noted above, when the contributor registers, the SDK 66 assists in associating the information from the contributor with that of the provider. It also allows for the contributor to set up the other places on the user's screen (See FIG. 4). The SDK 66 also provides a number of other tools that assist the contributor and beneficiary by incentivizing users to earn more points. For example, the SDK 66 provides the following tools:

Impact Points: Points are earned from participating in the activities and direct contributions to the beneficiaries and provide the basis for rankings and rewards;

Teams: Individuals can invite friends to join or create a team in support of a beneficiary or cause;

Alliances: Teams will be able to join other teams and form alliances in support of one or multiple beneficiary organizations;

Impact Actions: Actions highlight opportunities to use registered products (purchases) or invite friends to experience in exchange for points or rewards once the activity is completed;

Impact Challenges: Participants or teams can challenge each other to duels where winners earn points and loser could make a contribution or perform some impact action;

Impact Leaderboards: Ranks all users based on most points and includes all user types including contributors, beneficiaries, teams, alliances and Impact tools like Impact Empire;

Impact Empire: Encourages users to leverage their social circles and compete for more influence on impact. The users are then ranked based on the biggest network effects;

Impact Ads: Sponsors can pay to promote brand through ads, sponsored Impact Tools and registered products. Ads can also be used to promote platform registered Beneficiaries;

Rewards: In addition to points as rewards, Developers, Beneficiaries, Brands and Influencers will also be prompted to register rewards for point leaders, which may include bonus points, prizes from contributors or even virtual goods (in-app purchases); and

Donations: Users will be able to donate to beneficiaries for larger amounts of points.

As noted above, the system 10 collects the data about the use of the system 10. For the contributors, the data may include, for example, In-app purchases by users, paid downloads (music), sharing via social media, marketplace purchases, sponsor revenues, impact actions, impact challenges, ad revenue, and direct donations. The system also collects other information from the contributor. Some of that information is the preferred causes, the beneficiaries, the activity types.

For the beneficiaries, the system 10 collects goal information, impact information, deliverable producing activities, unit cost for production and/or client services, ranges for 30 day, 1 year, 3 year, and 10 year unit targets, and rewards or membership perks to contributors. The data also includes the location where the activities that were funded took place. For example, as illustrated in the bottom right corner of the user screen in FIG. 4, there is a map that will show users where all beneficiaries are located as well as which beneficiaries that the user is supporting. The map will show user the completeness percentage for the users impact goals. Users can also select to see friend's Impact where they can see where friends are creating impact. Naturally, this information can be presented in other ways such as in tabular or narrative form.

For the users, the system 10 cross references the data collected for the contributors, much of which applies to the users. However, the system 10 also Records information regarding friends, teams, music, purchases and messages.

To summarize each of the actions available to the users of the system 10, the users perform the following steps: Visit website; Register; Identify Causes to support; Select Contributor that supports beneficiaries with similar causes; Check out available activities on User's website page; download any relevant applications associated with system and/or contributor to participate in activities; Participate in activities to receive points; monitor impact activities have on beneficiary; see impact of beneficiary on causes; and check the impact of user versus other uses on the leaderboards.

For the contributors, they must register; identify causes/select beneficiary; identify activities to provide to users; use SDK/toolbox to integrate activities on contributor's IT structure into system; provide for download of any downloadable material; provide a marketplace for purchasing of goods (real and virtual); provide funds based on activities; monitor impact activities have on beneficiary; and issue challenges to the users and/or beneficiaries.

For the beneficiaries, they must visit the website; register; identify causes currently supporting; receive funds from contributor; provide goods/services related to identified causes; report on goods/services provided with funds; provide goals to the contributors and users; and can also issue challenges to the users and support their own users.

For the provider, it is its duty to provide a platform through the website; provide registration for users, contributors, and beneficiaries; provide a dashboard for the users, contributors, and beneficiaries; collect data on usage of activities by users, contributors and beneficiaries; collect data on the funds contributed by the contributors (by user); collect data on amount received by the beneficiaries; collect data on the goods/services provided by beneficiaries; and provide collected data to users/contributors/beneficiaries on leaderboards/dashboards.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A method of providing a platform to provide for contributions to a beneficiary and monitoring the contributions comprising the steps of:
providing an electronic platform to support multiple users accessing the platform;
providing access to at least one electronic area in the electronic platform for a registered user;
providing at least one activity for the registered user to engage in the at least one electronic area;
providing a point system to award points to the registered user based upon an activity engaged in by the registered user in the at least one electronic area;
awarding points under the point system to the registered user for participating in an activity;
contributing funds to a beneficiary, the contributed funds corresponding to the points awarded to the registered user;
receiving from the beneficiary a report on use of the funds by the beneficiary; and
reporting to the user the funds contributed to the beneficiary and the reported use of the funds through the electronic platform.

2. The method according to claim 1, wherein the at least one electronic area is supported by a contributor and the funds are provided by the contributor to the beneficiary.

3. The method according to claim 1, wherein the at least one electronic area comprises a plurality of electronic areas and each of the plurality of electronic areas is supported by a contributor.

4. The method according to claim 3, further providing a leaderboard, the leaderboard displaying the points awarded to users according to the contributors.

5. The method according to claim 1, wherein the at least one activity includes downloading electronic applications (apps), participating in discussion areas, purchasing of goods, viewing advertisements, and making donations.

6. The method according to claim 1, wherein the registered user purchases goods and/or services in the at least one activity.

7. The method according to claim 1, wherein the registered user may include a number of registered users that is considered to be a single entity for the purposes of awarding points.

8. The method according to claim 1, wherein the at least one activity includes the playing an electronic game on a handheld device that communicates with the system so the electronic platform may update the point system.

9. The method according to claim 1, wherein the reported use of the funds is done in a graphical format.

10. A system for providing a platform to provide for contributions to a beneficiary and monitoring the contributions, the system including at least one computer processor coupled with a tangible machine-readable medium having a set of instructions for a method stored thereon, the method comprising the steps of:
providing an electronic platform to support multiple users accessing the platform;
providing access to at least one electronic area in the electronic platform for a registered user;
providing at least one activity for the registered user to engage in the at least one electronic area;
providing a point system to award points to the registered user based upon an activity engaged in by the registered user in the at least one electronic area;
awarding points under the point system to the registered user for participating in an activity;
contributing funds to a beneficiary, the contributed funds corresponding to the points awarded to the registered user;
receiving from the beneficiary a report on use of the funds by the beneficiary; and
reporting to the user the funds contributed to the beneficiary and the reported use of the funds through the electronic platform.
